(19) United States
(12) Patent Application Publication
(10) Pub. No.: US 2006/0046562 A1
(43) Pub. Date: Mar. 2, 2006

(54) Apparatus for testing SATA port of motherboard

(75) Inventors: Ming-Shiu Ou Yang, Tu-Cheng (TW); Huang-Nien Lin, Tu-Cheng (TW); Wei-Yuan Chen, Tu-Cheng (TW); Tai-Chen Wang, Tu-Cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/204,852

(22) Filed: Aug. 16, 2005

(30) Foreign Application Priority Data
Aug. 25, 2004 (CN) 200410051258.0

(51) Int. Cl. H01R 13/66

(52) U.S. Cl. 439/541.5

(57) ABSTRACT

An apparatus (30) for testing a serial advanced technology architecture (SATA) port of a motherboard. The apparatus includes a flash memory chip (31), a first signal converting chip (33) electrically connected to the flash memory chip, and a second signal converting chip (35) electrically connected to the first signal converting chip. The first and second signal converting chips cooperate to convert a flash memory signal to a SATA interface signal.

### BACKGROUND OF THE INVENTION

1. Field of the Invention

The present invention relates to a testing apparatus, and more particularly to a testing apparatus for a SATA port of a motherboard.

2. General Background

A typical motherboard has a plurality of Input/Output ports; for example, a Universal Serial Bus (USB) port, parallel ports, serial ports, and a serial advanced technology architecture (SATA) port. The motherboard is coupled to peripheral devices via the Input/Output ports to form a computing system.

Motherboards must be tested for quality before shipment. Conventionally, in test, a peripheral device is coupled to a motherboard under test via a corresponding Input/Output port to test whether the corresponding Input/Output function works well or not. For example, a SATA hard disk drive is coupled to the motherboard via a SATA port to test the SATA function. However, a conventional SATA hard disk drive is expensive, and this can increase the cost of testing. Furthermore, the SATA hard disk drive includes high precision moving mechanical parts. Consequently, the SATA hard disk drive is relatively slow, consumes significant amounts of power, and is prone to reliability problems especially if it sustains external shock or vibration. If the SATA hard disk drive operates unreliably, this may compromise the accuracy of the test.

What is desired, therefore, is a testing apparatus which economically and efficiently replaces a conventional SATA hard disk drive in the testing of a motherboard.

### SUMMARY

In one preferred embodiment, an apparatus is provided for testing a serial advanced technology architecture (SATA) port of a motherboard. The apparatus includes a flash memory chip, a first signal converting chip electrically connected to the flash memory chip, and a second signal converting chip electrically connected to the first signal converting chip. The first and second signal converting chips cooperate to convert a flash memory signal to a SATA interface signal.

Other advantages and novel features will become more apparent from the following detailed description of a preferred embodiment when taken in conjunction with the accompanying drawings, in which:

### BRIEF DESCRIPTION OF THE DRAWINGS

FIG. 1 is a schematic view of an apparatus for testing a SATA port of a motherboard in accordance with a preferred embodiment of the present invention; and

FIG. 2 is a flowchart of steps involved in testing the motherboard when using the apparatus of FIG. 1.

### DETAILED DESCRIPTION OF THE EMBODIMENT

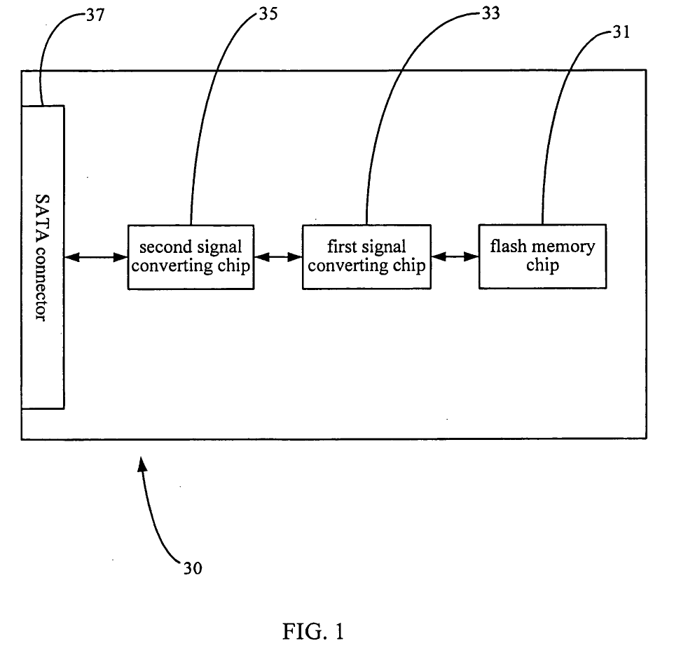

Referring to FIG. 1, an apparatus 30 is provided for testing a serial advanced technology architecture (SATA) port of a motherboard.

The apparatus 30 includes a flash memory chip 31, a first signal converting chip 33, a second signal converting chip 35, and a SATA connector 37, all of which are electrically connected in sequence. The flash memory chip 31 has a predetermined storage capacity and is used as a substitute functional device of a functional component like the SATA hard disk drive electrically connectable to the motherboard. The first signal converting chip 33 is an IDE-flash (Integrated Drive Electronics-flash) signal converter, for converting between IDE interface signals and flash memory signals. The second signal converting chip 35 is a SATA-IDE signal converter, for converting between SATA interface signals and IDE interface signals.

In test, the apparatus 30 is connected to the SATA port of the motherboard under test via the SATA connector 37. The motherboard sends a test signal of request to the apparatus 30. The flash memory chip 31 feeds back a flash memory signal which contains information of storage capacity. The flash memory signal is first converted to an IDE interface signal by the first signal converting chip 33. Then, the IDE interface signal is converted to a SATA interface signal via the second signal converting chip 35. The SATA interface signal is sent to the motherboard under test via the SATA connector 37.

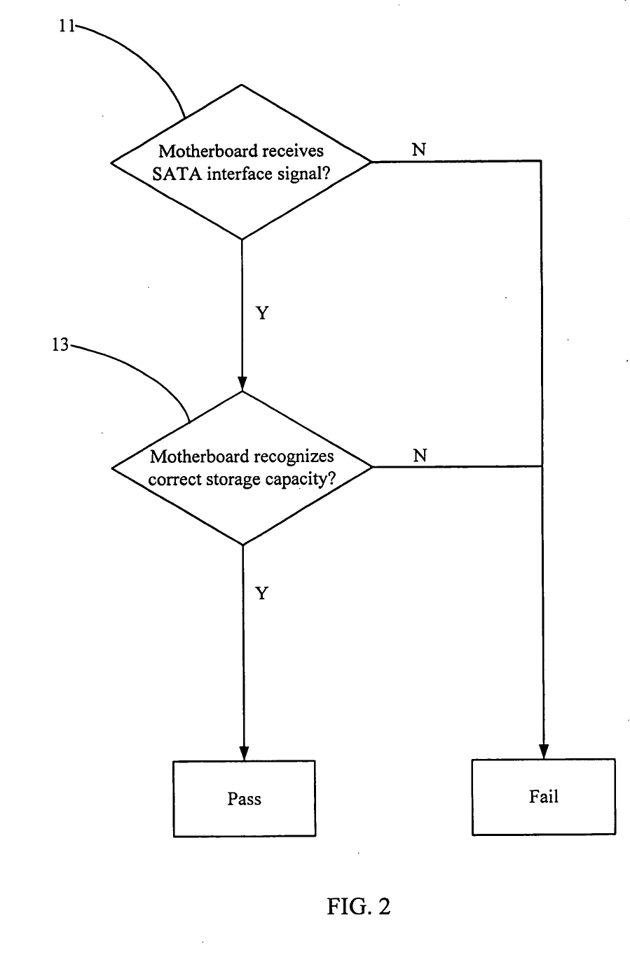

Referring particularly to FIG. 2, step 11 is determining whether or not the motherboard receives the SATA interface signal fed back by the apparatus 30. If the motherboard does not receive the SATA interface signal, the motherboard fails the test. If the motherboard receives the SATA interface signal, the procedure goes to step 13. Step 13 is determining whether or not the motherboard recognizes the correct storage capacity of the flash memory chip 31. If the motherboard does not recognize the correct storage capacity of the flash memory chip 31, the motherboard fails the test. If the motherboard recognizes the correct storage capacity of the flash memory chip 31, the motherboard passes the test.

The apparatus 30 simulates the function of a conventional SATA hard disk drive in the test. The apparatus 30 is cheaper than the SATA hard disk drive. Furthermore, the apparatus 30 has three chips instead of moving mechanical parts as required by the SATA hard disk drive. Therefore, the apparatus 30 is more reliable, as well as being faster and consuming less power than the SATA hard disk drive.

It is believed that the present embodiment and its advantages will be understood from the foregoing description, and it will be apparent that various changes may be made thereto without departing from the spirit and scope of the invention or sacrificing all of its material advantages, the example hereinbefore described merely being a preferred or exemplary embodiment.

What is claimed is:

1. An apparatus for testing a serial advanced technology architecture (SATA) port of a motherboard, comprising:
a flash memory chip;
a first signal converting chip electrically connected to the flash memory chip; and
a second signal converting chip electrically connected to the first signal converting chip, the first and second signal converting chips cooperating to convert a flash memory signal to a SATA interface signal.

2. The apparatus as claimed in claim 1, wherein the first signal converting chip is an IDE-flash (Integrated Drive Electronics-flash) signal converter, for converting between an IDE interface signal and a flash memory signal.

3. The apparatus as claimed in claim 1, wherein the second signal converting chip is a SATA-IDE (SATA-Integrated Drive Electronics) signal converter, for converting between a SATA interface signal and an IDE interface signal.

4. The apparatus as claimed in claim 1, further comprising a SATA connector electrically connected to the second signal converting chip.

5. An apparatus for simulating one or more functions of a conventional SATA (serial advanced technology architecture) hard disk drive, comprising:
a flash memory chip;
an IDE-flash (Integrated Drive Electronics-flash) signal converter electrically connected to the flash memory chip, for converting between an IDE interface signal and a flash memory signal;
a SATA-IDE signal converter electrically connected to the IDE-flash signal converter, for converting between a SATA interface signal and an IDE interface signal; and
a SATA connector electrically connected to the SATA-IDE signal converter.

6. The apparatus as claimed in claim 5, wherein the IDE-flash signal converter is a chip.

7. The apparatus as claimed in claim 5, wherein the SATA-IDE signal converter is a chip.

8. A method to test a connecting port of a circuit board, comprising the steps of:
preparing a substitute functional device for a functional component compatibly and electrically connectable to a connecting port of a circuit board;
electrically connecting said substitute functional device with said connecting port;
retrieving responsive signals from said substitute functional device based on a request signal from said circuit board through said connecting port;
converting said responsive signals to signals compatible to said connecting port; and
verifying said signals received by said circuit board through said connecting port to acquire test results of said connecting port of said circuit board.

9. The method as claimed in claim 8, wherein said responsive signals are converted twice in said converting step.

10. The method as claimed in claim 9, wherein said functional component is a serial advanced technology architecture (SATA) hard disk drive and said substitute functional device is a flash memory chip, said responsive signals from said flash memory chip is first converted to Integrated Drive Electronics-flash (IDE) signals, then converted to SATA signals compatible to said connecting port.

11. The method as claimed in claim 9, wherein at least two signal converting chips are used to convert said responsive signals twice to said signals compatible to said connecting port.
